(19) United States
(12) Patent Application Publication
(10) Pub. No.: US 2012/0249034 A1
(43) Pub. Date: Oct. 4, 2012

(54) POSITION SENSING CIRCUIT FOR BRUSHLESS MOTORS

(75) Inventor: Kevin Allan Dooley, Mississauga (CA)

(73) Assignee: PRATT & WHITNEY CANADA CORP., Longueuil (CA)

(21) Appl. No.: 13/075,284

(22) Filed: Mar. 30, 2011

(51) Int. Cl. H02P 6/18

(52) U.S. Cl. 318/400.35

(57) ABSTRACT

A position sensing circuit (14) for a brushless electric motor (10) is described. The position sensing circuit (14) comprises an input (16) adapted to receive a voltage induced by a rotor (1) in at least one winding (L1, L2 and L3) of the stator (2) when that winding is not driven; and a detection device (18) inductively coupled to the input (16) and configured to generate a signal representative of a position of the rotor (1) in relation to the stator (2) based on the induced voltage.

### TECHNICAL FIELD

The disclosure relates generally to the control of brushless electric motors, and more particularly to systems, devices and methods useful in commutation of current through windings of such motors.

### BACKGROUND OF THE ART

To effectively drive a brushless direct current (BLDC) motor, a motor control system requires accurate information on the position of the rotor in relation to the stator. Sensors such as Hall effect sensors may be used to sense rotor position.

However, the use of such sensors increases cost and weight, decreases reliability, and subjects the motor to temperature limitations imposed by the operational limitations of the sensors.

A form of sensorless control of (BLDC) motors is known; it typically involves establishing the rotor speed and/or position based on induced electromotive force (EMF) or back-EMF occurring in an non-energized stator winding. One known technique involves monitoring zero voltage crossings in the EMF generated in the non-energized (non-driven) motor winding in order to determine the position of the rotor. The position of the rotor is then fed back to motor control circuitry and used to provide a proper commutation sequence to stator windings.

Windings of BLDC motors may carry noisy signals which can create challenges in the accurate detection of zero voltage crossings in the generated EMF. For example, windings may carry common mode voltages and switching noise associated with commutation drive signals. Accordingly, the detection of zero voltage crossings in the generated EMF using conventional circuitry and devices directly connected to windings of BLDC motors may present limitations. Improvement in sensorless control is therefore desirable.

### SUMMARY

The disclosure describes electric machines, and in particular improved systems, devices, and processes useful in determining the position of a rotor in relation to a stator of an electric machine. Systems, devices, and processes described herein may also be useful for sensorless control of electric machines such as, for example, BLDC motors.

In various aspects, for example, the disclosure describes a position sensing circuit for a brushless electric motor comprising a stator having a plurality of windings and a rotor. The position sensing circuit may comprise:

an input adapted to receive a voltage induced by the rotor in at least one of the windings of the stator when that winding is not driven; and

a detection device inductively coupled to the input and configured to generate a signal representative of a position of the rotor in relation to the stator based on the induced voltage.

The detection device may be configured to detect a rotor-induced zero crossing in one or more of the windings of the stator. The detection device may be coupled to the input via an isolation transformer.

In one aspect, the disclosure describes a brushless direct current electric motor which may comprise a stator and a cooperating rotor. The stator may have a plurality of windings. The motor may also comprise circuitry useful in control of the motor, the circuitry being configured to:

receive a voltage induced by the rotor in at least one of the windings of the stator when that winding is not driven; and

use an inductively transferred voltage from the induced voltage to generate a signal representative of a position of the rotor in relation to the stator.

In another aspect, the disclosure describes a method for generating a signal useful in the control of a brushless electric motor, wherein the motor may comprise a stator having a plurality of windings and a cooperating rotor. The method may comprise:

receiving a voltage induced by the rotor in at least one of the windings of the stator when that winding is not driven; and

using an inductively transferred voltage from the induced voltage to generate a signal representative of a position of the rotor in relation to the stator.

Further details of these and other aspects of the subject matter of this application will be apparent from the detailed description and drawings included below.

### DESCRIPTION OF THE DRAWINGS

Reference is now made to the accompanying drawings, in which:

FIG. 1A is a partial mechanical schematic representation of a 3-phase sensorless brushless direct current (BLDC) motor;

FIG. 1B is a partial electrical schematic representation of the motor of FIG. 1A;

FIG. 2 is a partial schematic representation of a motor drive circuit that may be useful in controlling a motor such as that shown in FIG. 1A; and

FIG. 3 is a schematic representation of a motor drive circuit that may be useful in controlling a motor such as that shown in FIG. 1A.

### DETAILED DESCRIPTION OF EMBODIMENTS

Various aspects of embodiments are described through reference to the drawings.

The disclosure relates to control of a polyphase (e.g. 3-phase) sensorless BLDC motor and may be suited for use, for example, with machine configurations such as those described in the applicant's U.S. Pat. Nos. 6,965,183; 7,262,539; 7, 288,910 and 7,443,642, the entire contents of which are incorporated herein by reference. Systems, devices and methods described herein may also be used with various forms of sensorless control of BLDC motors involving the measurement of rotor speed and/or position based on rotor-induced electromotive force (EMF) occurring in an non-energized (e.g. not driven) stator winding. For example, systems, devices and methods described herein may be useful in controlling brushless motors according to the disclosure of U.S. patent application Ser. No. 12/713,730, which is incorporate herein by reference.

The operation of a BLDC motor can be improved through the use of accurate information on the position of the rotor in relation to the stator. The position of a permanent magnet rotor may be obtained using sensors such as Hall effect sensors. However, in many applications sensorless control is desired. Benefits of the sensorless solution include, for example, the elimination of position sensors and their connections between the control system and the motor; reduced cost and weight; improved reliability and the removal of temperature limitations imposed by the operational limitations of the position sensors.

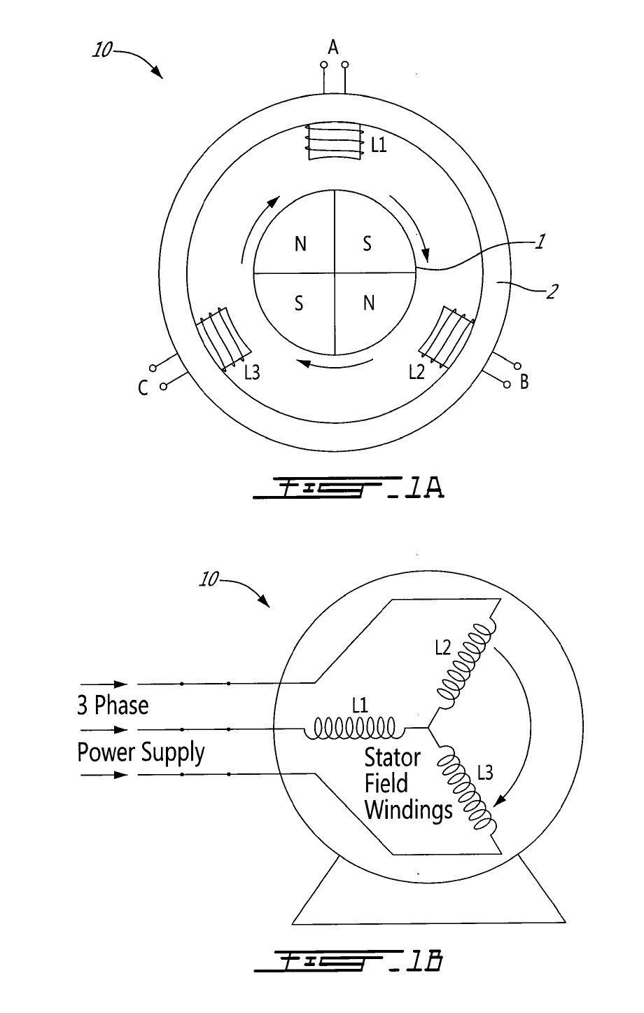

One known technique to obtain information on the position of the rotor in relation to the stator involves monitoring zero voltage crossings in the generated EMF (e.g. rotor-induced voltage(s)) occurring in non-energized (non-driven) windings of the motor. Zero crossing events occur when generated EMF signals equal the voltage of the motor's neutral point. Thus, to determine when a zero-crossing event occurs, control circuitry of a sensorless BLDC motor must have information regarding the neutral voltage of the motor phase windings L1, L2 and L3 (see for example FIGS. 1A and 1B). For a 3-phase WYE wound motor, a center tap directly connected to the neutral point of the motor windings (i.e. the common point of the three phase coils schematically arranged similar to the letter “Y”) may provide information regarding the neutral voltage of the motor phase windings L1, L2 and L3.

FIGS. 1A and 1B show partial schematic representations of a 3-phase BLDC motor 10, including stator windings L1, L2 and L3. Motor 10 may comprise a rotor 1 having at least one permanent magnet in addition to a stator 2 comprising windings L1, L2 and L3. It is to be understood that motor 10 may be an electric machine that may operate either as a motor or as a generator. As shown in FIG. 1B, stator windings L1, L2 and L3 may be arranged in a WYE configuration. Alternatively, windings L1, L2 and L3 may be arranged in a delta configuration where devices, systems and/or methods disclosed herein could also be used to detect zero-crossings in any undriven windings L1, L2 and/or L3. For example, motor 10 may comprise an electric machine that may be used as a starter/generator coupled to a gas turbine engine (not shown) for an aircraft application.

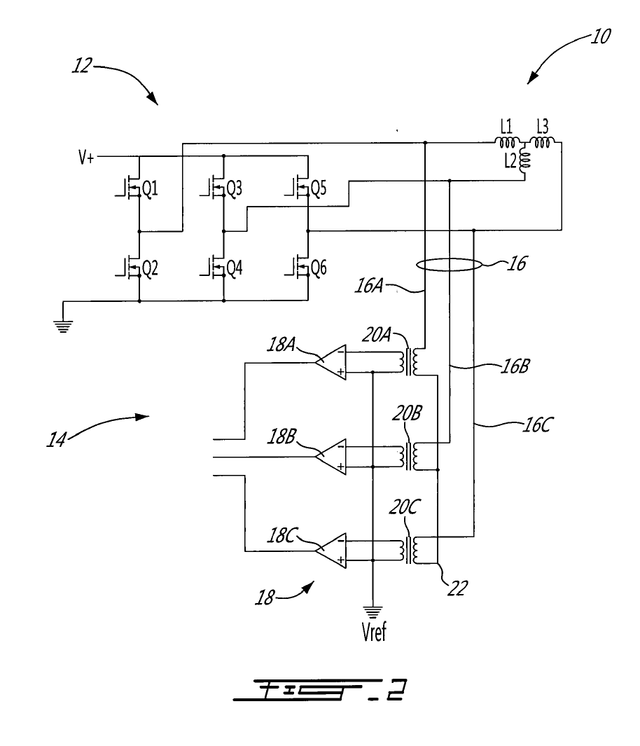

FIG. 2 shows a schematic representation of commutation circuitry, generally shown at 12, and a position sensing circuit, generally shown at 14, that may be used to drive a motor 10 in accordance with the disclosure. Commutation circuitry 12 may comprise a plurality of switching elements Q1-Q6 used to commutate current through windings L1, L2 and L3 of motor 10. Switching elements Q1-Q6 may, for example, each comprise one or more metal-oxide-semiconductor field-effect transistors (MOSFETs) or other suitable switching device(s). Current commutated through windings L1, L2 and L3 may be provided by a source of direct current (DC) such as one or more batteries, rectifiers, and/or DC generators, for example.

Position sensing circuit 14 may be used to generate one or more signal(s) representative of a position of the rotor 1 in relation to the stator 2 of motor 10 during operation. Signal(s) generated by a position sensing circuit 14 may be used to drive switches Q1-Q6 of commutation circuitry 12 to commutate input current through windings L1, L2 and L3 to cause the rotor 1 to rotate in relation to the stator 2 and thereby control, for example, a torque and/or speed of motor 10.

Position sensing circuit 14 may comprise input source(s) such as lines or connections 16, and detection device(s) 18. Detection device(s) 18 may be inductively coupled to input 16. Detection device(s) 18 may for example comprise conventional or other voltage comparators 18A-18C. Input 16 may be adapted to receive voltage(s) (e.g. generated-EMF(s)) induced by the rotor 1 in one or more of windings L1, L2 and L3 of the stator 2 of motor 10 when that(those) winding(s) is(are) not driven. Accordingly, input 16 may comprise individual inputs 16A-16C each connectable to a respective one of windings L1, L2 and L3 of motor 10. Comparators 18A-18C may be configured to generate a signal representative of a position of the rotor 1 in relation to the stator 2 based on the induced voltage. Comparators 18A-18C may be configured to detect a rotor-induced zero crossing based on induced voltage in respective ones of windings L1, L2 and L3.

Comparator(s) 18A-18C may, for example, be inductively coupled to corresponding input(s) 16A-16C via respective isolation transformer(s) 20A-20B. It is to be understood that a position sensing circuit 14 may comprise a single input (e.g.

16A) adapted to receive a voltage induced in only one winding (e.g. L1) and a single comparator (e.g. 18A) inductively coupled to input 16A. Alternatively, a plurality of inputs 16A-16C and comparators 18A-18C may be used to monitor voltages induced in a plurality of the windings L1, L2 and L3. For example, the number of inputs 16A-16C and corresponding comparators 18A-18C may be selected to match the number of windings L1, L2 and L3 (e.g. phases) of motor 10. Hence, the detection of rotor-induced zero crossings may be conducted on any of or all of the windings L1, L2 and L3.

Transformer(s) 20A-20C may be configured to inductively couple comparator(s) 18A-18C to input(s) 16A-16C which may each be directly connected to a respective one of winding(s) L1, L2 and L3. Accordingly, transformer(s) 20A-20C may also provide isolation between comparator(s) 18A-18C and input(s) 16A-16C. The inductive isolation provided by transformer(s) 20A-20C may prevent or reduce common mode voltages and switching noise present on winding(s) L1, L2 and L3 from being transferred to comparator(s) 18A-18C. Transformers(s) 20A-20C may prevent DC signals from being transferred to comparator(s) 18A-18C. Transformer(s) 20A-20C may also be configured to ratio (e.g. step-down) voltages received at input(s) 16A-16C to a level suitable for comparator(s) 18A-18C and/or any other electronic devices or circuitry that may be part of or connected to position sensing circuit 14.

Transformer(s) 20A-20C may comprise individual voltage transformer(s) configured to inductively couple comparator(s) 18A-18C to respective inputs 16A-16C. Transformer(s) 20A-20C may be configured as a conventional or other suitable polyphase transformer(s). For example, a conventional transformer such as model no. TTC-2035 sold under the trade name Tamura Corporation of America could be used in some applications. It is to be understood that the selection of suitable transformer(s) could readily be made by one skilled in the relevant arts based on specific applications and associated requirements.

The arrangement of transformer(s) 20A-20C connected across each of the windings provides a virtual (regenerated) neutral point 22 which may be useful in the monitoring of zero voltage crossings in rotor-induced voltage(s) in non-energized (non-driven) winding(s) L1, L2 and L3 of motor 10. Accordingly, an additional conductor (center tap) directly connected to the actual neutral point of the motor winding(s) L1, L2 and L3 may not be required.

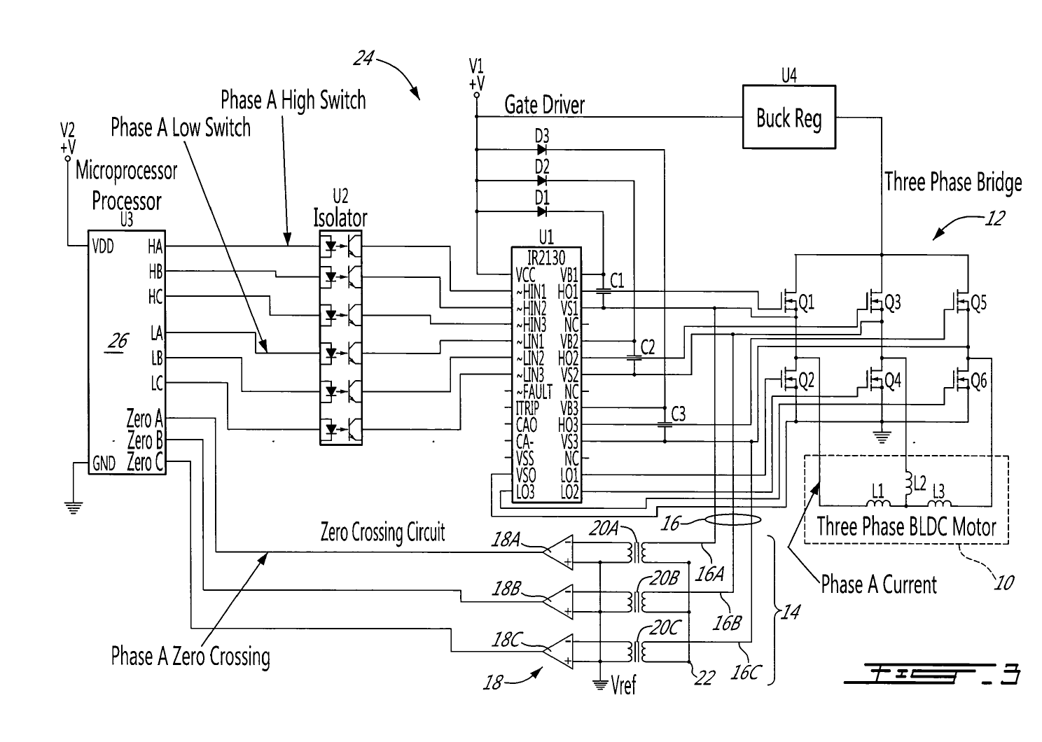

FIG. 3 shows a motor drive circuit 24 suitable for use in driving a motor 10 in accordance with the disclosure herein. In the embodiment shown, drive circuit 24 includes commutation circuitry 12 and position sensing circuit 14 of FIG. 2. Motor drive circuit 24 may further include microprocessor(s) 26 and other components useful in controlling motor 10 and commutating an input current through windings L1, L2 and L3 to cause the rotor 1 to rotate in relation to the stator 2 and also control the speed and output torque of motor 10. Microprocessor(s) 26 may be configured to receive a signal(s) from comparators 18A-18C of position sensing circuit 14. Microprocessor(s) 26 may generate a signal(s) useful in the driving of switching elements Q1-Q6 of commutation circuitry 12. Power phases commutated to field windings L1, L2 and L3 may be identified as phases A, B and C respectively.

During operation, a motor 10 may be started using, for example, methods that are known in the art. Motor drive circuit 24 may be used to control motor 10 by suitably commutating input power through windings L1, L2 and L3 based on rotor position feedback received from position sensing circuit 14. As the rotor 1 rotates relative to the stator 2 and a permanent magnet of the rotor 1 passes a non-driven stator winding, such as winding L1 for example, the motion of the permanent magnet relative to winding L1 induces a voltage (e.g. generated EMF) in winding L1 relative to the neutral point of motor 10 described above. Such rotor-induced voltage may generally have a sinusoidal waveform which may be monitored and used to determine the position of the rotor 1 in relation to the stator 2. A rotor-induced zero crossing occurs when the induced voltage crosses from either a positive voltage to a negative voltage or from a negative voltage to a positive voltage in relation to the neutral point. The detection of a rotor-induced zero crossing is of particular interest because it may be used to determine a specific angular position of the rotor 1 in relation to the stator 2 without requiring a separate sensor such as an encoder or a Hall effect sensor. The detection of a rotor-induced zero crossing may therefore be used, by the microprocessor 26 for example, in determining a suitable commutation order.

Rotor-induced voltages in windings L1, L2 and L3 may be inductively transferred to detection devices 18A-18C via transformers 20A-20C. As explained above, transformers 20A-20C may be interconnected at point 22 which may serve as a virtual (e.g. regenerated) neutral point 22 against which rotor-induced voltages in windings L1, L2 and L3 may be compared to detect rotor-induced zero crossings. Accordingly, an additional conductor directly connected to the actual neutral point of the motor windings L1, L2 and L3 may not be required. Since the induced voltages transferred by transformers 20A-20C are relative to virtual neutral 22, comparators 18A-18C may simply compare the inductively transferred voltage(s) from respective transformers 20A-20C to a reference voltage Vref as shown in FIGS. 2 and 3. For example, reference voltage Vref may be that of a ground (e.g. a zero voltage reference). By comparing the inductively transferred voltage to a ground, each of the comparators 18A-18C may detect a rotor-induced zero crossing when the sign of the inductively transferred voltage changes from positive to negative or from negative to positive relative to neutral point 22. Upon detection of a rotor-induced zero crossing, one or more of the comparators 18A-18C may generate a signal representative of a position of the rotor 1 in relation to the stator 2. The signal generated by each of the comparators 18A-18C may be received by microprocessor(s) 26 and used to control motor 10 by commutating current through windings L1-L3 of motor 10.

Windings L1, L2 and L3 of sensorless polyphase BLDC motors such as motor 10 may generate or carry noisy and/or irregular signals which can create challenges in the accurate detection of rotor-induced zero crossings using conventional systems. For example, windings may be subjected to common mode voltages and switching noise due to rapid switching in commutation circuitry 12. The use of a transformer (e.g. inductive) coupling between a detection device 18 and an input 16 provides an effective means of filtering out (suppressing) such unwanted signals and DC signals while permitting the rotor-induced voltage of sinusoidal shape to be inductively transferred to detection device 18.

The transformer coupling between detection device 18 and input 16 can also be used to provide isolation of sensitive device(s) in motor drive circuitry 24 from potentially dangerous or otherwise undesirable voltage(s) from any of windings L1, L2 and L3. For example, the use of one or more transformers 20A-20B allows for induced voltage(s) in windings L1, L2 and L3 to be stepped down to a level suitable for commonly available and relatively inexpensive circuitry and electronic components to be used in position sensing circuit 14 and/or any other component(s) that may be connected to position sensing circuit 14. Accordingly, such electronic components may not need to be adapted to accommodate relatively large voltages/currents that may be induced in windings L1, L2 and L3.

The use of transformer coupling between detection device 18 and input 16 may also provide an efficient way of transmitting useful signals to detection device 18 while suppressing noise and/or other unwanted signals, such as DC signal components. Position sensing circuit 14 may not require the use of resistive circuits that typically entail energy losses in the form of heat in order to regenerate a virtual neutral. Accordingly, position sensing circuit 14 may not create significant energy losses or place significant additional loading on motor 10. However, position sensing circuit 14 may comprise resistive and/or resistive-capacitive networks in addition to winding inductances of transformers 20A-20C to provide additional filtering capability if needed or desired.

The above descriptions are meant to be exemplary only. Those skilled in the relevant arts will recognize that changes may be made to the embodiments described without departing from the scope of the present disclosure. For example, the method does not specifically require a 3-phase brushless DC motor but may be used with all types of brushless permanent magnet motors. A 3-phase motor may be preferred because in many cases it simplifies the associated electronics by allowing the use of commercially-available circuits designed to be used with three Hall effect sensors to sense rotor position.

Methods and systems according to the disclosure may also be used in conjunction with motors serving as starter motors (not shown) driving a shaft for, as an example, starting a gas turbine engine (not shown).

It will also be understood by those skilled in the relevant arts that systems and methods according to the disclosure herein may be used in conjunction with motors having either an “inside rotor” configuration or an “outside rotor” configuration as disclosed, for example, in U.S. Pat. No. 6,965,183. Still other modifications which fall within the scope of the described subject matter will be apparent to those skilled in the art, in light of a review of this disclosure, and such modifications are intended to fall within the appended claims.

What is claimed is:

1. A position sensing circuit for a brushless electric motor comprising a stator having a plurality of windings and a rotor, the position sensing circuit comprising:
an input adapted to receive a voltage induced by the rotor in at least one of the windings of the stator when that winding is not driven; and
a detection device inductively coupled to the input and configured to generate a signal representative of a position of the rotor in relation to the stator based on the induced voltage.

2. The circuit as defined in claim 1, wherein the detection device is configured to detect a zero crossing.

3. The circuit as defined in claim 1, wherein the detection device is coupled to the input via an isolation transformer.

4. The circuit as defined in claim 3, wherein the detection device comprises a comparator configured to compare a voltage output from the transformer to a reference voltage.

5. The circuit as defined in claim 4, wherein the reference voltage is that of a ground.

6. The circuit as defined in claim 1, wherein the input comprises individual inputs each adapted to receive a voltage induced in a respective one of the windings of the stator and the detection device comprises a plurality of comparators inductively coupled to a respective one of the individual inputs.

7. The circuit as defined in claim 6, wherein the comparators are coupled to the respective inputs via respective transformers.

8. The circuit as defined in claim 7, wherein the transformers are configured to generate a virtual neutral.

9. The circuit as defined in claim 8, wherein the comparators are each configured to compare a voltage output from a respective one of the transformers to a ground.

10. The circuit as defined in claim 6, wherein the comparators are coupled to the respective inputs via a polyphase isolation transformer.

11. The circuit as defined in claim 6, wherein the comparators are each configured to detect a zero crossing.

12. A brushless direct current electric motor comprising:
a stator and a cooperating rotor, the stator having a plurality of windings; and
circuitry useful in control of the motor, the circuitry being configured to:
receive a voltage induced by the rotor in at least one of the windings of the stator when that winding is not driven; and
use an inductively transferred voltage from the induced voltage to generate a signal representative of a position of the rotor in relation to the stator.

13. The electric motor as defined in claim 12, wherein the circuitry is configured to detect a rotor-induced zero crossing.

14. The electric motor as defined in claim 12, wherein the windings comprise three windings and the circuitry is configured to receive rotor-induced voltage from each of the three windings.

15. The electric motor as defined in claim 14, wherein the circuitry comprises a polyphase isolation transformer.

16. The electric motor as defined in claim 15, wherein the polyphase isolation transformer is configured to generate a virtual neutral.

17. The electric motor as defined in claim 12, wherein the inductively transferred voltage is stepped-down from the induced voltage.

18. A method for generating a signal useful in the control of a brushless electric motor, wherein the motor comprises a stator having a plurality of windings and a cooperating rotor, the method comprising:
receiving a voltage induced by the rotor in at least one of the windings of the stator when that winding is not driven; and
using an inductively transferred voltage from the induced voltage to generate a signal representative of a position of the rotor in relation to the stator.

19. The method as defined in claim 18, wherein the induced voltage is relative to a virtual neutral.

20. The method as defined in claim 19 comprising comparing the inductively transferred voltage to a ground.
